(19) United States
(12) Patent Application Publication
(10) Pub. No.: US 2017/0061823 A1
(43) Pub. Date: Mar. 2, 2017

(54) SYSTEM FOR TRACKING AND MONITORING PERSONAL MEDICAL DATA AND ENCOURAGING TO FOLLOW PERSONALIZED CONDITION-BASED PROFILE AND METHOD THEREOF

(71) Applicant: HELLO DOCTOR LTD., TEL AVIV (IL)

(72) Inventors: Maayan COHEN, PALO ALTO, CA (US); Ziv MELTZER, TEL AVIV (IL)

(73) Assignee: HELLO DOCTOR LTD., TEL AVIV (IL)

(21) Appl. No.: 15/251,225

(22) Filed: Aug. 30, 2016

Related U.S. Application Data
(60) Provisional application No. 62/213,131, filed on Sep. 2, 2015.

(51) Int. Cl. G09B 19/00; G09B 5/12; G06F 19/00

(52) U.S. Cl. CPC G09B 19/0092; G06F 19/3406; G09B 5/125

(57) ABSTRACT

A system and method of monitoring and displaying the health data of an individual, said system comprising: a mobile device for receiving health parameters of said individual corresponding to outcomes of individual's health parameter measurements, said mobile device further comprising: a receiver module operative to accept said transmitted health parameters of said individual corresponding to outcomes of said individual's health parameter measurements; a processor module operative to record and generate continuous personal health profile based on said health parameters reflective of the current health state of the individual and compare said personal health profile with a set of predetermined reference parameters to determine where each said personal health profile is corresponding to on a parameter's health scale; a user interface module operative to display said transmitted health parameters of said individual corresponding to outcomes of said individual's health parameter measurements and simultaneously display all representative values of the health parameters in a digital and graphical form; an alarm module operative to alarm-monitor transmitted health parameters of said individual corresponding to outcomes of said individual's health parameter measurements and provide an indication of said personal health profile if it is in the normal or in-alarm region, as differentiated by predetermined alarm criteria; a data storage module operative to store a data record of predetermined format for each said individual corresponding to outcomes of said individual's health parameter measurements; and a network connection coupled to said mobile device, said network connection configured to utilize a network protocol to interface with user interface module and output representative values of the health parameters in a digital and graphical form.

### FIELD OF THE INVENTION

The present invention relates to system and methods for tracking, monitoring and displaying individual's personal medical and health-related measurements and encouraging to follow personalized condition-based profile.

### BACKGROUND OF THE INVENTION

In the past, physicians commonly monitored patient well-being via health parameter measurements made during regularly scheduled office visits. During recent years, however, with the introduction of personal mobile devices, steadily increasing healthcare costs and outpatient populations have created a need to maximize time intervals between office visits. As a result, a number of vital health monitoring functions once directly performed by nurses and physicians have largely become patient self-care responsibilities.

Early detection of a decline in health can be critical for effective treatment. Checkups at medical facilities can be useful for early detection, but are sometimes too infrequent to provide immediate detection of a decline in health, especially cognitive health where declines can happen rapidly and without being easily noticed by friends and family.

Health monitoring systems can be used to help individuals to facilitate important communications with remote caregivers. For example, such systems can send and receive messages, track normal activity patterns, and warn of any changes. They may also provide medication and appointment reminders, and call 911 in an emergency. Systems for monitoring health remotely with respect to the medical facilities, for example monitoring health in the home, do exist. Some of these existing systems fail to make adequate use of resources that may already be available in the home of an individual, which can result in these existing systems being prohibitively expensive and/or difficult to deploy and/or benchmark with the rest of the measured population. The present invention is an improvement upon existing health behavior systems in that it provides an enhanced gamification support system to help users follow a personalized condition-based profile and lifestyle change encouragement by providing insights, reports and in-system explanations.

Therefore, a long felt need still exists for system and methods for tracking, monitoring and displaying individual's personal medical and health-related measurements and encouraging to follow personalized condition-based profile.

### SUMMARY OF THE INVENTION

It is thus an object of the present invention to provide a method of monitoring and displaying the health data of an individual, comprising the steps of: receiving transmitted health parameters of said individual corresponding to outcomes of said individual's health parameter measurements; recording and generating continuous personal health profile based on said health parameters reflective of the current health state of the individual; comparing said personal health profile with a set of predetermined reference parameters to determine where each said personal health profile is corresponding to on a parameter's health scale; providing an indication of said personal health profile if it is in the normal or in-alarm region, as differentiated by predetermined alarm criteria; generating a reward sub-profile for said user who accomplishes an intermediate milestone based on an ultimate goal of associated health parameter measurements; and simultaneously displaying all representative values of the health parameters in a digital and graphical form.

It is another object of the present invention to provide a system of monitoring and displaying the health data of an individual, said system comprising: a mobile device for receiving health parameters of said individual corresponding to outcomes of individual's health parameter measurements, said mobile device further comprising: a receiver module operative to accept said transmitted health parameters of said individual corresponding to outcomes of said individual's health parameter measurements; a processor module operative to record and generate continuous personal health profile based on said health parameters reflective of the current health state of the individual and compare said personal health profile with a set of predetermined reference parameters to determine where each said personal health profile is corresponding to on a parameter's health scale; a user interface module operative to display said transmitted health parameters of said individual corresponding to outcomes of said individual's health parameter measurements and simultaneously display all representative values of the health parameters in a digital and graphical form; an alarm module operative to alarm-monitor transmitted health parameters of said individual corresponding to outcomes of said individual's health parameter measurements and provide an indication of said personal health profile if it is in the normal or in-alarm region, as differentiated by predetermined alarm criteria; a gamification reward module operative to generating a reward sub-profile for said user who accomplishes an intermediate milestone based on an ultimate goal of associated health parameter measurements; a data storage module operative to store a data record of predetermined format for each said individual corresponding to outcomes of said individual's health parameter measurements; and a network connection coupled to said mobile device, said network connection configured to utilize a network protocol to interface with user interface module and output representative values of the health parameters in a digital and graphical form.

It is another object of the present invention to provide a non-transitory computer-readable medium having stored thereon instructions that, when executed by a computerized device, cause said computerized device to execute a computer-implemented method comprising: receiving transmitted health parameters of said individual corresponding to outcomes of said individual's health parameter measurements; recording and generating continuous personal health profile based on said health parameters reflective of the current health state of the individual; comparing said personal health profile with a set of predetermined reference parameters to determine where each said personal health profile is corresponding to on a parameter's health scale; providing an indication of said personal health profile if it is in the normal or in-alarm region, as differentiated by predetermined alarm criteria; generating a reward sub-profile for said user who accomplishes an intermediate milestone based on an ultimate goal of associated health parameter measurements; and simultaneously displaying all representative values of the health parameters in a digital and graphical form.

### BRIEF DESCRIPTION OF THE PREFERRED EMBODIMENTS

The novel features believed to be characteristics of the invention are set forth in the appended claims. The invention itself, however, as well as the preferred mode of use, further objects and advantages thereof, will best be understood by reference to the following detailed description of illustrative embodiment when read in conjunction with the accompanying drawings, wherein:

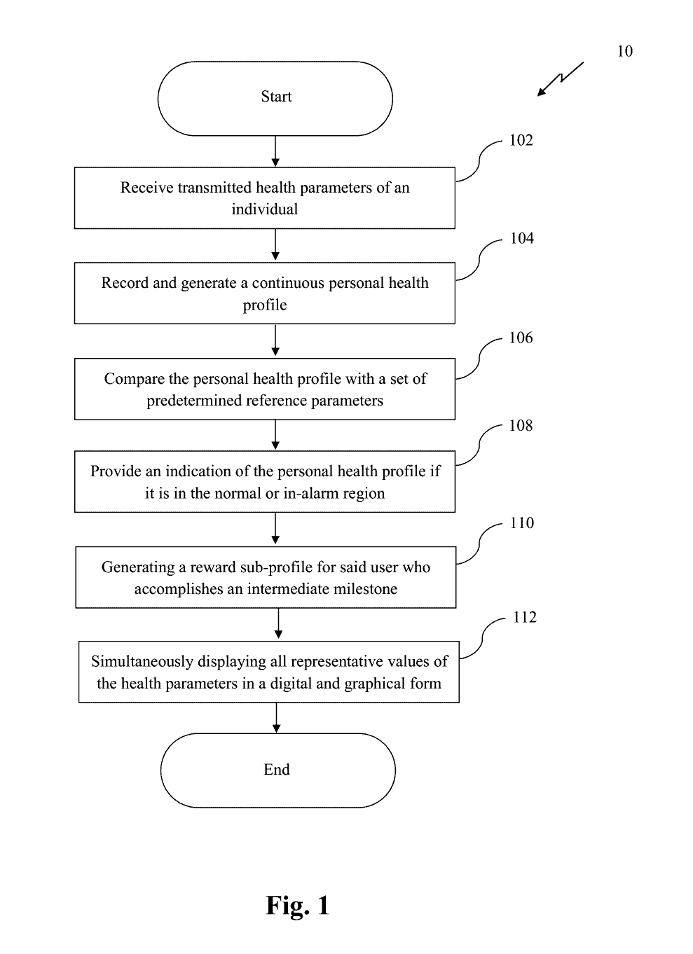

FIG. 1 presents a top level scheme of the method disclosed by the present invention; and

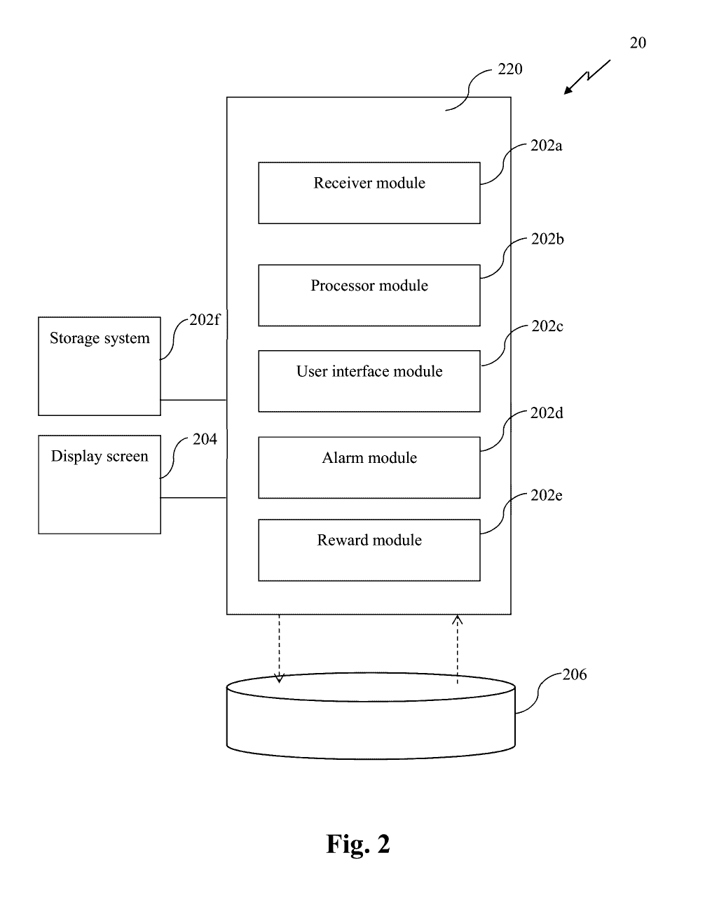

FIG. 2 presents an embodiment of the system disclosed by the present invention.

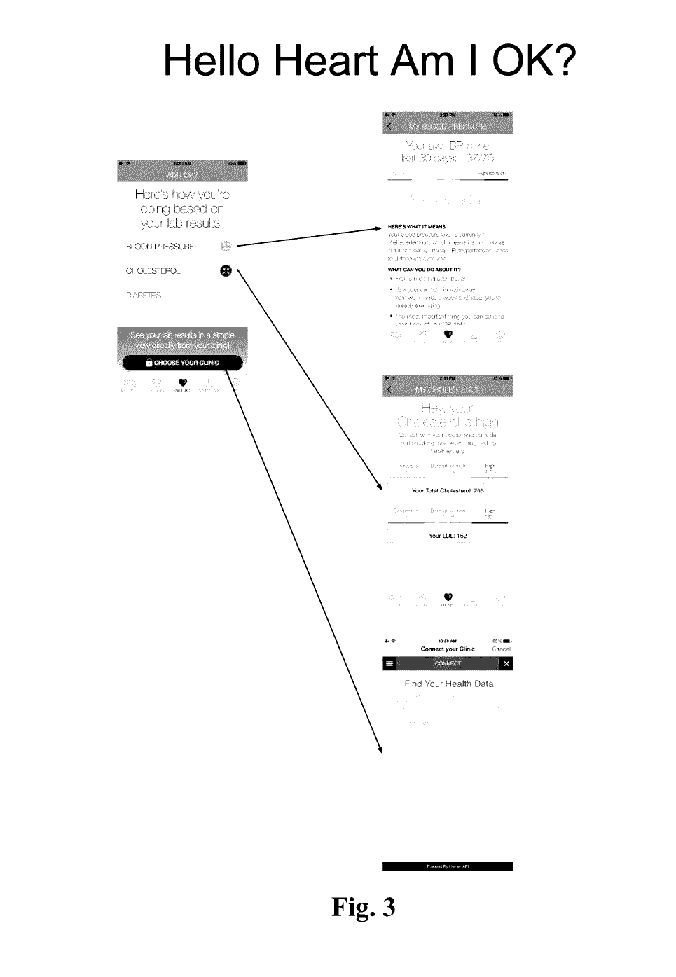

FIG. 3-10 are a representation of the embodiment of a screen shot of the user interface.

### DETAILED DESCRIPTION OF THE PREFERRED EMBODIMENTS

The following description is provided, alongside all chapters of the present invention, so that to enable any person skilled in the art to make use of the invention and sets forth the best modes contemplated by the inventor of carrying out this invention.

In the following detailed description of the preferred embodiments, reference is made to the accompanying drawings that form a part hereof, and in which are shown by way of illustration specific embodiments in which the invention may be practiced. It is understood that other embodiments may be utilized and structural changes may be made without departing from the scope of the present invention. The present invention may be practiced according to the claims without some or all of these specific details. For the purpose of clarity, technical material that is known in the technical fields related to the invention has not been described in detail so that the present invention is not unnecessarily obscured.

Reference throughout this specification to “one embodiment” or “an embodiment” module that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

While the technology will be described in conjunction with various embodiment(s), it will be understood that they are not intended to limit the present technology to these embodiments. On the contrary, the present technology is intended to cover alternatives, modifications and equivalents, which may be included within the spirit and scope of the various embodiments as defined by the appended claims.

Furthermore, in the following description of embodiments, numerous specific details are set forth in order to provide a thorough understanding of the present technology. However, the present technology may be practiced without these specific details. In other instances, well known methods, procedures, components, and circuits have not been described in detail as not to unnecessarily obscure aspects of the present embodiments.

Unless specifically stated otherwise as apparent from the following discussions, it is appreciated that throughout the present description of embodiments, discussions utilizing terms such as “receiving,” “operative, “alarming” “capturing,” “corresponding,” “monitoring,” “displaying,” “classifying”, “configuring” or the like, refer to the actions and processes of a computer system, or similar electronic computing device. The computer system or similar electronic computing device manipulates and transforms data represented as physical (electronic) quantities within the computer system's registers and memories into other data similarly represented as physical quantities within the computer system memories or registers or other such information storage, transmission, or display devices, including integrated circuits down to and including chip level firmware, assembler, and hardware based micro code.

The term “mobile device” interchangeably refers, but not limited to such as a mobile phone, laptop, tablet, cellular communicating device, digital camera (still and/or video), PDA, computer server, video camera, television, electronic visual dictionary, communication device, personal computer, and etc. The present invention module and methods are performed in a standalone electronic device comprising at least one screen. Additionally or alternatively, at least a portion of such as processing, memory accessible, databases, includes a cloud-based platform, and/or web-based platform. In some embodiments, the software components and/or image databases provided, are stored in a local memory module and/or stored in a remote server.

The term “data storage” interchangeably refers hereinafter to any memory that can be accessed and interfaced with by a machine (e.g. computer) including, but not limited to, high-speed random access memory and may also include non-volatile memory, such as one or more magnetic disk storage devices, flash memory devices, or other non-volatile solid-state memory devices, a direct-access data storage media such as hard disks, CD-RWs and DVD-RW can also be used to store software components and/or medical records databases.

The term “display” interchangeably refers hereinafter to any visual representation on a regular/touch-sensitive surface, known in the art. The user can navigate between the graphical outputs presented on the screen, and interact with presented digital navigation. Additionally or alternatively, the present application can be connected to a user interface detecting input from a keyboard, a button, a click wheel, a touchpad, a roller, a computer mouse, a motion detector, sound detector, speech detector, joystick, and etc., for activating or deactivating particular functions. A user can navigate among and interact with one or more graphical user interface objects that represent at least visual navigation content, displayed on screen. In some embodiments the interaction is by module such as computer mouse, motion sensor, module of a touch screen, keyboard, voice activation, joystick, electronic pad and pen, touch sensitive pad, a designated set of buttons, soft keys, and the like.

The present invention relates to system and method for tracking, monitoring and displaying individual's personal medical and health-related measurements and encourages the individual to follow personalized condition-based profile.

Embodiments of the present invention provide gamification modules and methods as means to increase patient engagement—rewards, badges and other rewards are given.

Mobile technology is used to raise awareness to health—mobile notifications and reminders to check BP, and take drugs appropriately, increasing prescription compliance.

Personalized explanations are used to create motivation in the patient.

Personalized health tips are provided as input to comply with healthy lifestyle recommendations—activity, stress management and nutrition tips. Tips will be presented to different users according to the users' current behavior analysis and a smart engine that chooses what worked best for similar users.

Using motivators—creating sense of urgency to get engaged in your health by using “motivators” content that links reduction of blood pressure to immediate outcome on look and quality of life

Reference is now made to FIG. 1, schematically illustrating a high level overview of the method 10 disclosed in the present invention. The first step 102 provided in the disclosed method receiving transmitted health parameters of said individual corresponding to outcomes of said individual's health parameter measurements. Transmitted health parameters are detected or monitored by a variety of digital input sources.

Method 10 then follows to step 104, comprising recording and generating continuous personal health profile based on said health parameters reflective of the current health state of the individual. Data representing the health parameters is transmitted to a mobile device where the data is stored.

A software process analyzes the input data from a given source and detects changes over time, for example by use of a moving average or other statistical metrics. This analysis is incorporated in step 106, comprising comparing said personal health profile with a set of predetermined reference parameters to determine where each said personal health profile is corresponding to on a parameter's health scale. The input data from multiple sources can be analyzed against previous data.

Significant results or changes in those metrics trigger notification to a user of the application in the step 108, comprising providing an indication of said personal health profile if it is in the normal or in-alarm region, as differentiated by predetermined alarm criteria.

A software process then generates a reward sub-profile for said user who accomplishes an intermediate milestone based on an ultimate goal of associated health parameter measurements in step 110.

This indication is further displayed in step 112, comprising simultaneously displaying all representative values of the health parameters in a digital and graphical form.

In various embodiments of the present invention, the measurements are stored in a database, which could be in a non-limiting example a server, a cloud based server, a personal computer and any combination thereof. In other embodiments, the measurements stored in the database could be linked or referenced to one another in a network of measurements, correlating to the referenced health data they originally were extracted from.

In various embodiments of the present invention, the health measurements allow the system to assess the appropriate at least one incentive to be issued to the user in a form of activities selected from the group consisting of exercise performed; activities dedicated to improving or maintaining mental and emotional balance and health; activities dedicated to improving or maintaining medications' usage; and activities dedicated to improving or maintaining nutritional or dietary habits. The user can be notified of his/her medications and vital signs tracking and the progression of his/her personalized plan.

In various embodiments of the present invention, the system allows the user to be engaged in their health management by helping him/her understand their health profile. In the example below, in the research performed based on the outcome of using the present invention, the users showed a significant improvement in their blood pressure condition.

| | % of users | | | | Average | Median |
|---|---|---|---|---|---|---|
| | who decrease | pValue | | | number | number of BP |
| Changes of | their blood | (Increase & | Average | median | of BP readings | readings a |
| 10 mmHG | pressure | Decrease) | decresae | decrease | a week | week |
| At least 2 | 20% | 0.00000002 | −21 | −15.8 | 6 | 4 |
| weeks of BP | | | | | | |
| At least 3 | 20% | 0.00000029 | −21 | −16.0 | 6 | 4 |
| weeks of BP | | | | | | |
| At least 4 | 22% | 0.00000054 | −21 | −16.0 | 7 | 4 |
| weeks of BP | | | | | | |
| At least 5 | 22% | 0.00002209 | −22 | −16.0 | 7 | 4 |
| weeks of BP | | | | | | |
| At least 6 | 23% | 0.00003179 | −24 | −18.3 | 7 | 4 |
| weeks of BP | | | | | | |

The health profile database, may be accessed by only the sign-in user, which could be accessed only be providing the access code to the control unit of the device.

Reference is now made to FIG. 2, schematically illustrating an embodiment of the system disclosed by the present invention 20. A user launches a mobile application comprising a system for tracking, monitoring and displaying individual's personal medical and health-related measurements. In order to track, monitor and display individual's personal medical and health-related measurements, a mobile device 202 for receiving health parameters of said individual corresponding to outcomes of individual's health parameter measurements is provided, comprising a receiver module operative to accept said transmitted health parameters of said individual corresponding to outcomes of said individual's health parameter measurements 202a; a processor module operative to record and generate continuous personal health profile based on said health parameters reflective of the current health state of the individual and compare said personal health profile with a set of predetermined reference parameters to determine where each said personal health profile is corresponding to on a parameter's health scale 202b; a user interface module operative to display via a display screen 204 said transmitted health parameters of said individual corresponding to outcomes of said individual's health parameter measurements and simultaneously display all representative values of the health parameters in a digital and graphical form 202c; an alarm module operative to alarm-monitor transmitted health parameters of said individual corresponding to outcomes of said individual's health parameter measurements and provide an indication of said personal health profile if it is in the normal or in-alarm region, as differentiated by predetermined alarm criteria 202d; a gamification reward module operative to generate a reward sub-profile for said user who accomplishes an intermediate milestone based on an ultimate goal of associated health parameter measurements 202e; a data storage module operative to store a data record of predetermined format for each said individual corresponding to outcomes of said individual's health parameter measurements 202f; and a network connection coupled to said mobile device, said network connection configured to utilize a network protocol to interface with user interface module and output representative values of the health parameters in a digital and graphical form 206.

Reference is now made to FIG. 3, illustrating embodiments of a screen shot of the user interface presenting an example of health parameters.

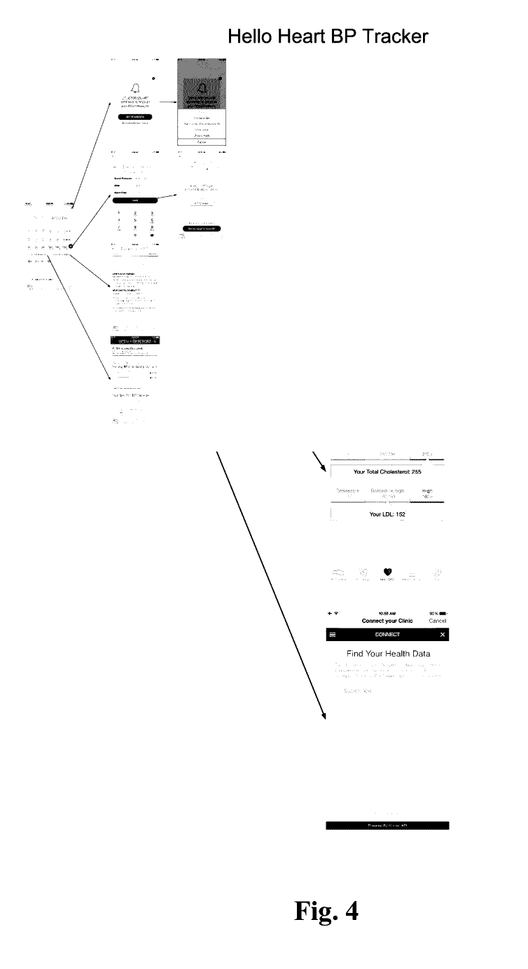

Reference is now made to FIG. 4, illustrating embodiments of a screen shot of the user interface presenting an example of a health parameter tracker.

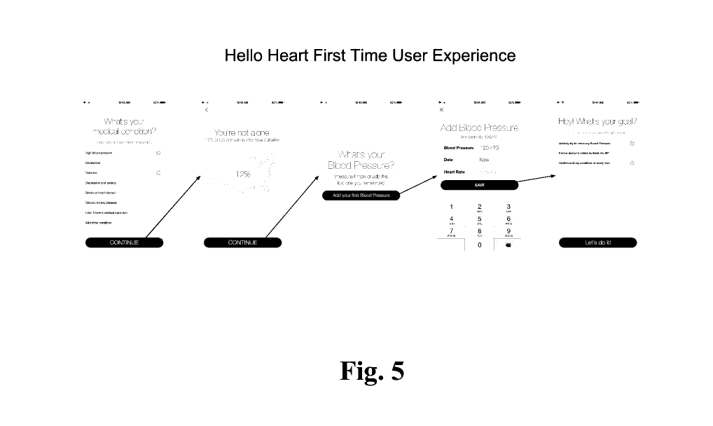

Reference is now made to FIG. 5, illustrating embodiments of a screen shot of the user interface presenting an example of a first user experience health parameters input.

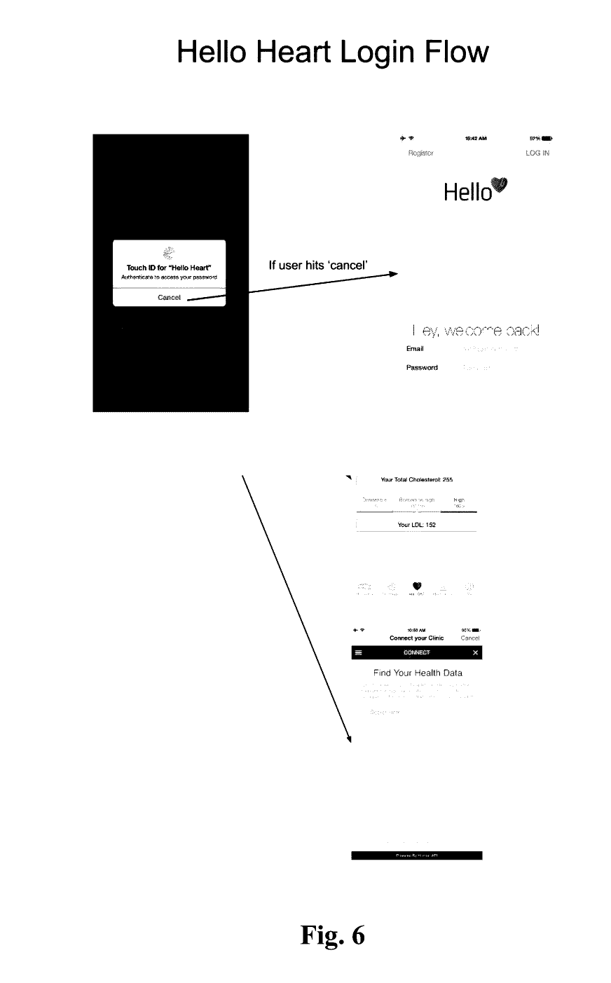

Reference is now made to FIG. 6, illustrating embodiments of a screen shot of the user interface presenting an example of a user login flow.

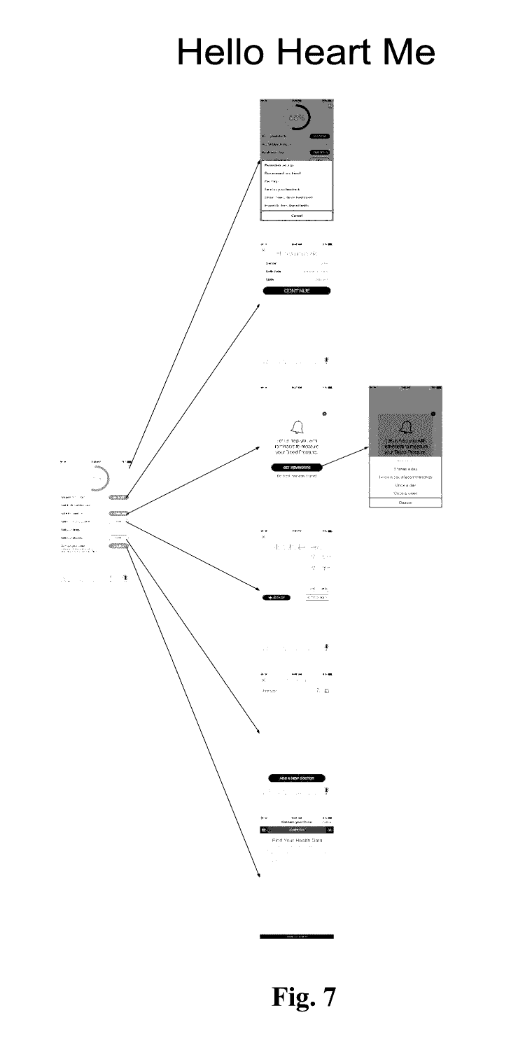

Reference is now made to FIG. 7, illustrating embodiments of a screen shot of the user interface presenting an example of an alarming and/or notification module.

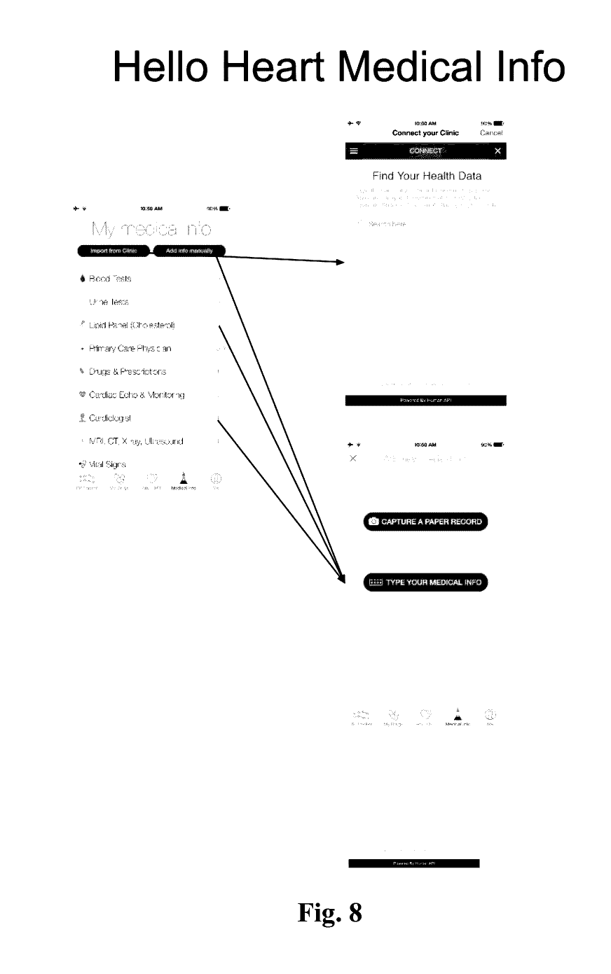

Reference is now made to FIG. 8, illustrating embodiments of a screen shot of the user interface presenting an example of a user's medical profile.

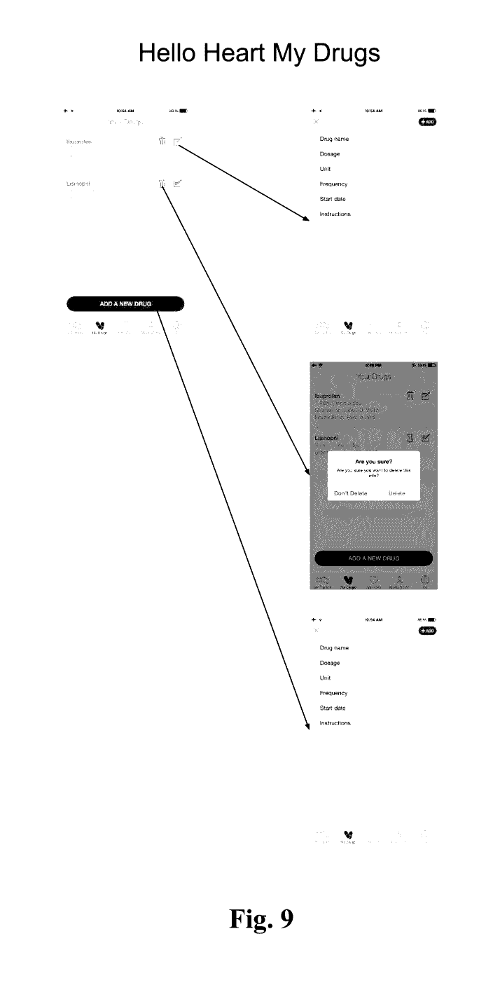

Reference is now made to FIG. 9, illustrating embodiments of a screen shot of the user interface presenting an example of drugs parameter management.

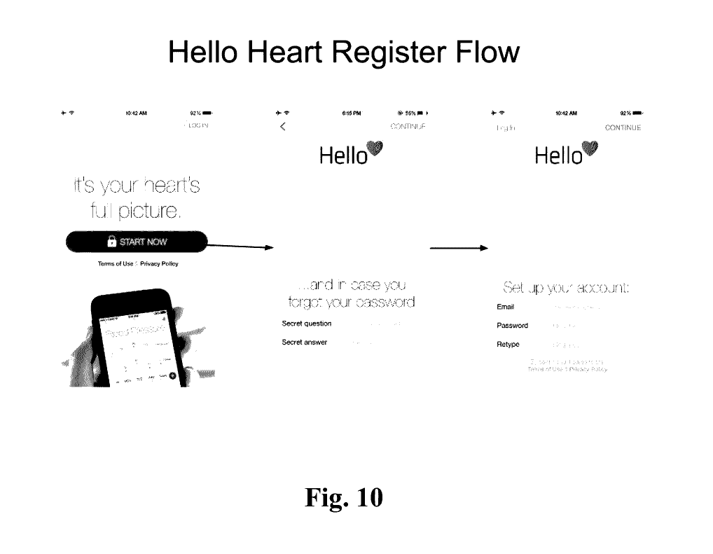

Reference is now made to FIG. 10, illustrating embodiments of a screen shot of the user interface presenting an example of a registration flow.

While the invention is susceptible to various modifications and alternative forms, specific embodiments thereof have been shown by way of example in the drawings and the above detailed description. It should be understood, however, that it is not intended to limit the invention to the particular forms disclosed, but on the contrary, the intention is to cover all modifications, equivalents, and alternatives falling within the spirit and scope of the invention as defined by the appended claims.

1. A computer-implemented method of monitoring and displaying the health data of an individual, comprising the steps of:
a. receiving transmitted health parameters of said individual corresponding to outcomes of said individual's health parameter measurements;
b. recording and generating continuous personal health profile based on said health parameters reflective of the current health state of the individual;
c. comparing said personal health profile with a set of predetermined reference parameters to determine where each said personal health profile is corresponding to on a parameter's health scale;
d. providing an indication of said personal health profile if it is in the normal or in-alarm region, as differentiated by predetermined alarm criteria;
e. generating a reward sub-profile for said user who accomplishes an intermediate milestone based on an ultimate goal of associated health parameter measurements; and
f. simultaneously displaying all representative values of the health parameters in a digital and graphical form.

2. The computer-implemented method of monitoring and displaying the health data of an individual according to claim 1, wherein the health parameters consist from a group of blood pressure, cholesterol, diabetes risk factors, AiC tests, triglycerides, biotin, blood alcohol content, pulse, blood glucose, body fat percentage, body temperature, caffeine, calcium, carbohydrates, chloride, chromium, copper, electrodermal activity, fiber, folate, heart rate, iodine, iron, magnesium, manganese, molybdenum, monounsaturated fat, niacin, oxygen saturation, pantothenic acid, phosphorus, polyunsaturated fat, potassium, protein, respiratory rate, riboflavin, saturated fat, selenium, sodium, sugar, thiamin, total fat, Vitamin A, Vitamin B12, Vitamin B6, Vitamin C, Vitamin D, Vitamin E, Vitamin K, weight, zinc, physical activity level, number of steps taken, smoking factors, alcohol consumption factors, stress level, and any combination thereof.

3. The computer-implemented method of monitoring and displaying the health data of an individual according to claim 1, wherein the health parameters displayed in a qualitative and quantitative form enhance health awareness.

4. The computer-implemented method of monitoring and displaying the health data of an individual according to claim 3, wherein the health parameters displayed in a qualitative and quantitative form on said parameter's health scale.

5. The computer-implemented method of monitoring and displaying the health data of an individual according to claim 1, wherein said method further comprising a step of analyzing said personal health profile to determine and alarm-monitor medical outcome based on the health parameters on said parameter's health scale.

6. The computer-implemented method of monitoring and displaying the health data of an individual according to claim 1, wherein said method further comprising a step of assessing the appropriate at least one incentive to be issued to the user based on said health parameters.

7. The computer-implemented method of monitoring and displaying the health data of an individual according to claim 6, wherein the at least one incentive is any one or combination of the group of activities selected from the group consisting of exercise performed; activities dedicated to improving or maintaining mental and emotional balance and health; activities dedicated to improving or maintaining medications' usage; and activities dedicated to improving or maintaining nutritional or dietary habits.

8. The computer-implemented method of monitoring and displaying the health data of an individual according to claim 1, wherein said method further comprising a step of notifying said user of his/her medications and vital signs tracking.

9. A system of monitoring and displaying the health data of an individual, said system comprising:
a. a mobile device for receiving health parameters of said individual corresponding to outcomes of individual's health parameter measurements, said mobile device further comprising:
i. a receiver module operative to accept said transmitted health parameters of said individual corresponding to outcomes of said individual's health parameter measurements;
ii. a processor module operative to record and generate continuous personal health profile based on said health parameters reflective of the current health state of the individual and compare said personal health profile with a set of predetermined reference parameters to determine where each said personal health profile is corresponding to on a parameter's health scale;
iii. a user interface module operative to display said transmitted health parameters of said individual corresponding to outcomes of said individual's health parameter measurements and simultaneously display all representative values of the health parameters in a digital and graphical form;
iv. an alarm module operative to alarm-monitor transmitted health parameters of said individual corresponding to outcomes of said individual's health parameter measurements and provide an indication of said personal health profile if it is in the normal or in-alarm region, as differentiated by predetermined alarm criteria;
v. a gamification reward module operative to generating a reward sub-profile for said user who accomplishes an intermediate milestone based on an ultimate goal of associated health parameter measurements; and
vi. a data storage module operative to store a data record of predetermined format for each said individual corresponding to outcomes of said individual's health parameter measurements.
b. a network connection coupled to said mobile device, said network connection configured to utilize a network protocol to interface with user interface module and output representative values of the health parameters in a digital and graphical form.

10. The system of monitoring and displaying the health data of an individual according to claim 9, wherein the health parameters consist from a group of blood pressure, cholesterol, diabetes risk factors, AiC tests, triglycerides, biotin, blood alcohol content, pulse, blood glucose, body fat percentage, body temperature, caffeine, calcium, carbohydrates, chloride, chromium, copper, electrodermal activity, fiber, folate, heart rate, iodine, iron, magnesium, manganese, molybdenum, monounsaturated fat, niacin, oxygen saturation, pantothenic acid, phosphorus, polyunsaturated fat, potassium, protein, respiratory rate, riboflavin, saturated fat, selenium, sodium, sugar, thiamin, total fat, Vitamin A, Vitamin B12, Vitamin B6, Vitamin C, Vitamin D, Vitamin E, Vitamin K, weight, zinc, physical activity level, number of steps taken, smoking factors, alcohol consumption factors, stress level, and any combination thereof.

11. The system of monitoring and displaying the health data of an individual according to claim 9, wherein the health parameters displayed in a qualitative and quantitative form enhance health awareness.

12. The system of monitoring and displaying the health data of an individual according to claim 11, wherein the health parameters displayed in a qualitative and quantitative form on said parameter's health scale.

13. The system of monitoring and displaying the health data of an individual according to claim 9, wherein said processor module further operative to analyze said personal health profile to determine and alarm-monitor via said alarm module medical outcome based on the health parameters on said parameter's health scale.

14. The system of monitoring and displaying the health data of an individual according to claim 9, wherein said processor module further operative to assess the appropriate at least one incentive to be issued to the user based on said health parameters.

15. The system of monitoring and displaying the health data of an individual according to claim 14, wherein the at least one incentive is any one or combination of the group of activities selected from the group consisting of exercise performed; activities dedicated to improving or maintaining mental and emotional balance and health; activities dedicated to improving or maintaining medications' usage; and activities dedicated to improving or maintaining nutritional or dietary habits.

16. The system of monitoring and displaying the health data of an individual according to claim 9, wherein said method further comprising a step of notifying said user of his/her medications and vital signs tracking.

17. A non-transitory computer-readable medium having stored thereon instructions that, when executed by a computerized device, cause said computerized device to execute a computer-implemented method comprising:
a. receiving transmitted health parameters of said individual corresponding to outcomes of said individual's health parameter measurements;
b. recording and generating continuous personal health profile based on said health parameters reflective of the current health state of the individual;
c. comparing said personal health profile with a set of predetermined reference parameters to determine where each said personal health profile is corresponding to on a parameter's health scale;
d. providing an indication of said personal health profile if it is in the normal or in-alarm region, as differentiated by predetermined alarm criteria;
e. generating a reward sub-profile for said user who accomplishes an intermediate milestone based on an ultimate goal of associated health parameter measurements; and
f. simultaneously displaying all representative values of the health parameters in a digital and graphical form.

18. The non-transitory computer-readable medium according to claim 17, wherein the health parameters consist from a group of blood pressure, cholesterol, diabetes risk factors, AiC tests, triglycerides, biotin, blood alcohol content, pulse, blood glucose, body fat percentage, body temperature, caffeine, calcium, carbohydrates, chloride, chromium, copper, electrodermal activity, fiber, folate, heart rate, iodine, iron, magnesium, manganese, molybdenum, monounsaturated fat, niacin, oxygen saturation, pantothenic acid, phosphorus, polyunsaturated fat, potassium, protein, respiratory rate, riboflavin, saturated fat, selenium, sodium, sugar, thiamin, total fat, Vitamin A, Vitamin B12, Vitamin B6, Vitamin C, Vitamin D, Vitamin E, Vitamin K, weight, zinc, physical activity level, number of steps taken, smoking factors, alcohol consumption factors, stress level, and any combination thereof.

19. The non-transitory computer-readable medium according to claim 17, wherein the health parameters displayed in a qualitative and quantitative form enhance health awareness.

20. The non-transitory computer-readable medium according to claim 19, wherein the health parameters displayed in a qualitative and quantitative form on said parameter's health scale.

21. The non-transitory computer-readable medium according to claim 17, cause said computerized device to execute a computer-implemented method further comprising a step of analyzing said personal health profile to determine and alarm-monitor medical outcome based on the health parameters on said parameter's health scale.

22. The non-transitory computer-readable medium according to claim 17, cause said computerized device to execute a computer-implemented method further comprising a step of assessing the appropriate at least one incentive to be issued to the user based on said health parameters.

23. The non-transitory computer-readable medium according to claim 17, wherein the at least one incentive is any one or combination of the group of activities selected from the group consisting of exercise performed; activities dedicated to improving or maintaining mental and emotional balance and health; activities dedicated to improving or maintaining medications' usage; and activities dedicated to improving or maintaining nutritional or dietary habits.

24. The non-transitory computer-readable medium according to claim 17, cause said computerized device to execute a computer-implemented method further comprising a step of notifying said user of his/her medications and vital signs tracking.
